(19) United States
(12) Patent Application Publication
(10) Pub. No.: US 2007/0018971 A1
(43) Pub. Date: Jan. 25, 2007

(54) Double-action command temporizing for electronic commands operation on several devices

(75) Inventor: Milton Flavio De Macedo, Sao Bernardo do Campo (BR)

Correspondence Address: WOLF, BLOCK, SHORR AND SOLIS-COHEN LLP, 250 PARK AVENUE, 10TH FLOOR, NEW YORK, NY, 10177, US

(73) Assignee: TechInvest Ltda, Sao Paulo (BR)

(21) Appl. No.: 11/489,003

(22) Filed: Jul. 19, 2006

(30) Foreign Application Priority Data
Jul. 21, 2005 (BR) PI 0502874-4

(51) Int. Cl. G09G 5/00

(52) U.S. Cl. 345/184

(57) ABSTRACT

“DOUBLE-ACTION COMMAND TEMPORIZING FOR ELECTRONIC COMMANDS OPERATION ON SEVERAL DEVICES”, where a rotative button (4), through operating projections (5) in a plate of electronic circuit (1), forms a binary code giving information to an electronic microcontroller, concerning the updated position of the rotative button (4), being said position showed on the external panel of washing machines, drying machines and similar devices, as well as the time spent or to be spent during each function, and since the motor control is done by the microprocessor, it is possible to use a motor (7) which operation does not rely on its physical nature, being the said motor AC, CD, Synchronous, etc, therefore facilitating the use, being the energizing or de-energizing of all the electric and electronic circuit performed through the simple release or lock the contacts (10) and (11) against the projections (12) and (13).

This descriptive report refers to an invention patent concession request for an electrical-mechanical command linked to an electronic circuit plate, for functions control of several electrical-electronic devices, such as washing machines, washing tableware machines, drying machines and other devices that act through programs for operation of mechanical devices as washing motor, 10 centrifuge, valves and other, the operation made by double-action, that is, through electrical-electronic commands or mechanical movements.

Technique Condition

The conventional totally electronic commands, although of great accuracy, usually are of 15 difficult operation and visualization by the user, being necessary various commands buttons to choose the proper program, as well as to select the stages to accomplish. For example, for visualization of conventional washing and drying stages, various colors leds are necessary, which by its individual features do not allow the visualization of the stages, however, not offering to the 20 lady of the house a time indicator of the current stage or the stage in progress.

The lack of intermediary information concerning the time of each stage maintain the user in general held or alert till the cycle of each stage be completed.

Although the 100% mechanical timers highly facilitate the visualization by the user, they have a lot of movable parts as individual contacts for each command and, for example, valves, motor, etc. Because they are mechanical, these contacts do not allow the accurate and fast control of each element as changes of motor rotation direction per second, essential factor for washing machine, being such task performed by a big, expensive and complex gearing kit.

Patent Objective

The proposed double-action command join all the advantages of the totally electronic control with the practicability of the mechanical timer through a command formed by a rotative button with projections projected to form a binary code, giving to the electronic microcontroller, as per 15 the bottom position, constant information on the scheduled stage; information showed on the control panel of the machine, and also allowing the microcontroller, also after check the position of the rotative button, to perform the correspondent scheduled function, as well as to energize and 20 de-energize the hole electric and electronic circuit through contacts, operated only by lock or release with the correspondent projections.

After this brief explanation, see detailed information on the enclosed drawings, where you can see:

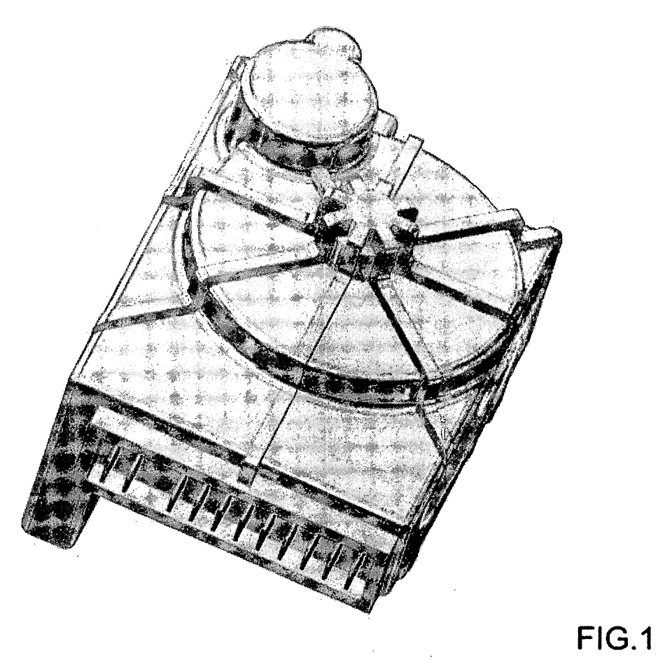

FIG. 1—Lower-posterior perspective view;

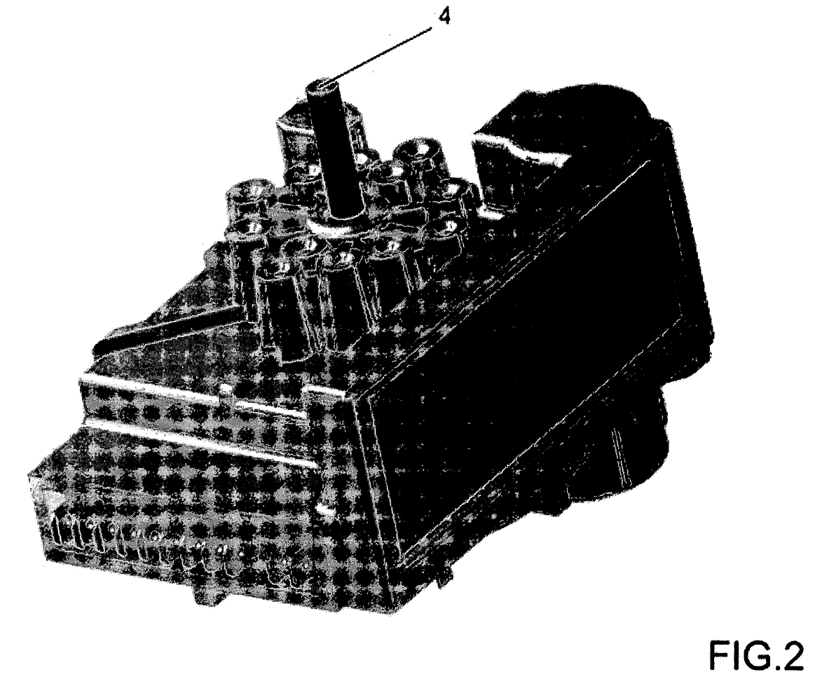

FIG. 2—Front-superior perspective view;

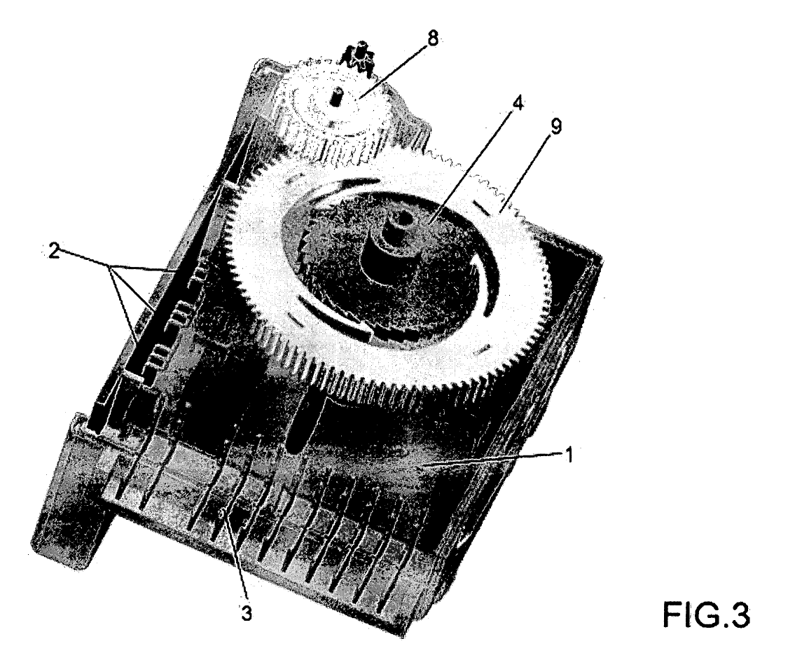

FIG. 3—Internal perspective view per FIG. 1;

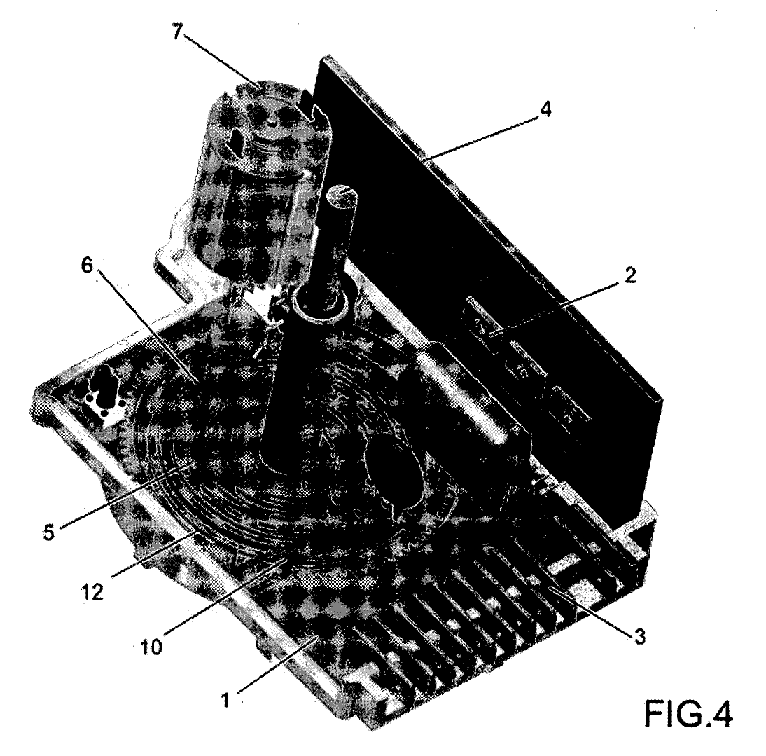

FIG. 4—Internal perspective view per FIG. 2;

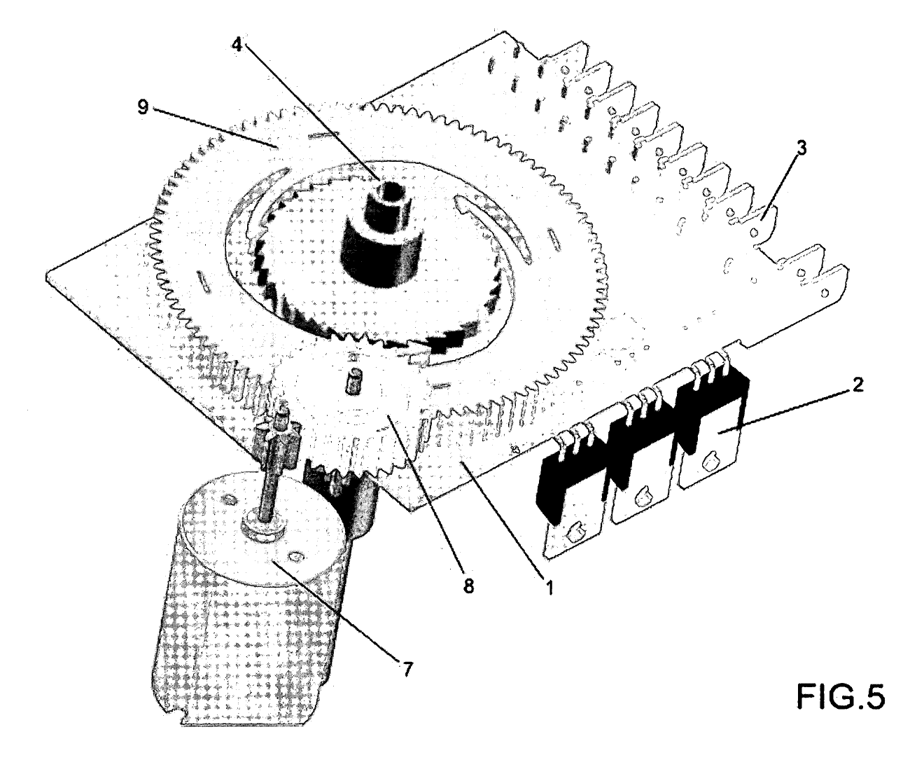

FIG. 5—Detailed view of the internal components, per FIGS. 1 and 3;

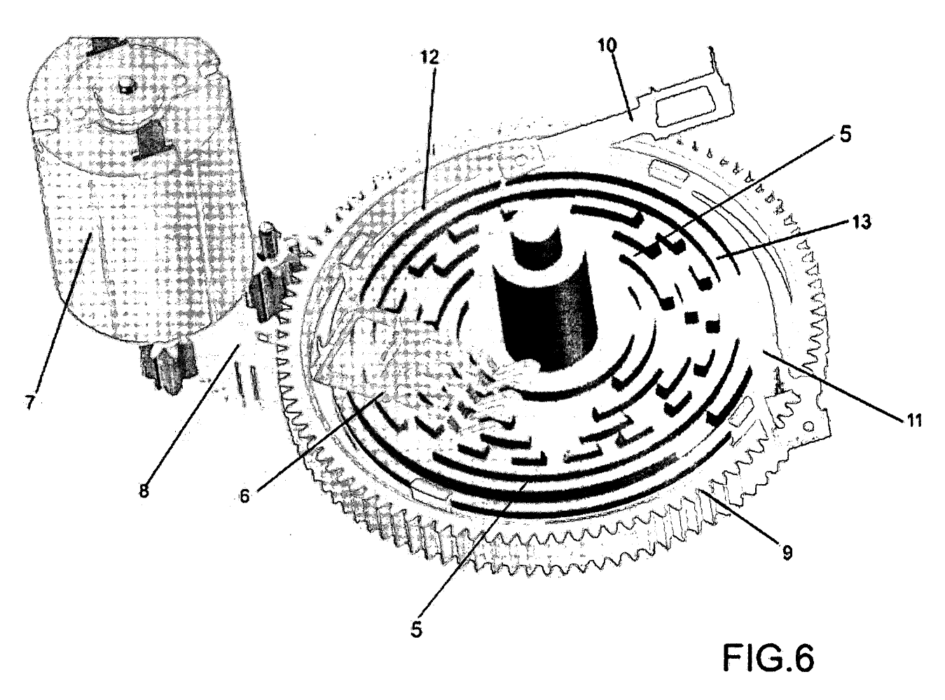

FIG. 6—Detailed view of the internal components, per FIGS. 2 and 4;

According to the enclosed drawings, the proposed “DOUBLE-ACTION COMMAND TEMPORIZING FOR ELECTRONIC COMMANDS OPERATION ON SEVERAL DEVICES.” joins all the advantages of the totally electronic control with the practicability of the program and visualization of the mechanical timer.

With this purpose, the command is composed by an electronic plate circuit (1) that through semi-conductors (2) controls the electric energy flow to the devices under control, such as valves, 15 motors, etc, which are connected to the connectors (3).

To program it is used a rotative button (4) that have several projections (5) previously distributed, forming a binary code that will give to the electronic microcontroller information concerning the current position of the rotative button (4). This position will be informed by the 20 rotative button movement that will cause the release or lock of the electric contacts (6).

So, through the rotation of the rotative button (4), the user will place the same on the program or part of the program that he wants and visualize through the indications of the machine external panel.

Once the rotative button (4) is activated by the user, the microcontroller will executed the correspondent programmed function, upon check its position—through the code produced by the electric contacts.

Through a conventional electric micro-motor (7) controlled by the micro-processor, the rotative button (4) will move clockwise, constantly indicating to the user the spent time of each

1) DOUBLE-ACTION COMMAND TEMPORIZING FOR ELECTRONIC COMMANDS OPERATION ON SEVERAL DEVICES”, formed by an electronic circuit plate (1) that, through semi-conductors (2) controls the electric energy flow to the devices under control as valves, motors and etc, which are connected to connectors (3), such plate (1) integrated to a rotative button (4) defined by several projections (5) previously distributed, to lock the electric contacts (6) that execute the function previously scheduled; such electric contacts (6) acting near the electric motor (7), linked to a gearing set (8) and a ratchet mechanism (9); such rotative button (4) including contacts (10) and (11) integrated as projections (12) and (13) energizing of electric and electronic circuit.

2) “ELECTRONIC COMMANDS OPERATION SYSTEM ON SEVERAL DEVICES”, according to the claim 1, defined by the projections (5) forming a binary code able to provide through de electronic circuit plate the updated information to the electronic microcontroller, concerning the position of the rotative button (4), position informed through the movement of the same rotative button (4), which rotation, after release or lock of the electric contacts (6), will place it in the program or part of the program desired and visualized through indications on the external panel of the machine, and after verify the button position (4) the microcontroller will execute the scheduled correspondent function, such movement conducted from the electric motor (7) to the rotative button (4), through the gearing set (8) and the ratchet mechanism (9).

3) “ELECTRONIC COMMANDS OPERATION SYSTEM ON SEVERAL DEVICES” according the claim 1, defined to avoid corrosion when the electric contacts of the lamina (6), performed in an isolate site by projections (5) of the rotative button (4), through a perpendicular movement relative the impress circuit position.

4) “ELECTRONIC COMMANDS OPERATION SYSTEM ON SEVERAL DEVICES” according the claim 1, defined by the energizing of the whole electric and electronic circuit through the contacts (10) and (11), activated only by the lock with the projections (12) and (13).

5) “ELECTRONIC COMMANDS OPERATION SYSTEM ON SEVERAL DEVICES” according to the claim 3, defined by the de-energizing of all the circuits of the machine, preventing shocks after the schedule conclusion, with the rotative button (4) placed in a way that the contacts (10) and (11) are open relative the projections (12) and (13).

6) “ELECTRONIC COMMANDS OPERATION SYSTEM ON SEVERAL DEVICES” according to the claim 1, defined by the utilization of any kind of electric motor, since the control of this motor is done by the microcontroller.
